(19) United States
(12) Patent Application Publication
(10) Pub. No.: US 2010/0034147 A1
(43) Pub. Date: Feb. 11, 2010

(54) SYSTEMS, METHODS AND APPARATUS FOR FACILITATING BUFFER STATUS REPORT ROBUSTNESS

(75) Inventors: Sai Yiu Duncan Ho, San Diego, CA (US); Srividhya Krishnamoorthy, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/536,746

(22) Filed: Aug. 6, 2009

Related U.S. Application Data
(60) Provisional application No. 61/087,918, filed on Aug. 11, 2008.

(51) Int. Cl. H04W 4/00; H04L 1/18; G06F 11/14

(52) U.S. Cl. 370/328; 714/748; 714/E11.113

(57) ABSTRACT

Systems, methods and apparatus for facilitating buffer status report robustness are provided. A method can include: transmitting a buffer status report, tracking an amount of time elapsed since transmitting the buffer status report; and determining, after a selected amount of time has elapsed, whether authorization to transmit buffered data has been received. The method can also include re-transmitting the buffer status report if the selected amount of time has elapsed and a data condition has been met. In some embodiments, the data condition is that information indicative of the authorization has not been received. In some embodiments, the method also includes determining, after the selected amount of time has elapsed, whether data is buffered for transmission, and the data condition is that information indicative of the authorization has not been received, and a determination has been made that data is buffered for transmission.

### CROSS-REFERENCE TO RELATED APPLICATIONS

This application claims the benefit of U.S. Provisional Patent Application Ser. No. 61/087,918 entitled “METHOD AND APPARATUS FOR BUFFER STATUS REPORT (BSR) ROBUSTNESS,” which was filed Aug. 11, 2008, and the entire contents of which are incorporated herein by reference.

### BACKGROUND

I. Field

The following description relates to wireless communications, in general, and to facilitating buffer status report (BSR) robustness in wireless communication systems, in particular.

II. Background

Wireless communication systems are widely deployed to provide various types of communication. For instance, voice and/or data can be provided via such wireless communication systems. A typical wireless communication system, or network, can provide multiple users access to one or more shared resources (e.g., bandwidth, transmit power). For instance, a system can use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Generally, wireless multiple-access communication systems can simultaneously support communication for multiple access terminals (ATs). Each AT can communicate with one or more base stations (BSs) via transmissions on forward and reverse links. The forward link (or downlink (DL)) refers to the communication link from BSs to ATs, and the reverse link (or uplink (UL)) refers to the communication link from ATs to BSs. This communication link can be established via a single-in-single-out, multiple-in-single-out or a multiple-in-multiple-out (MIMO) system. MIMO systems commonly employ multiple (N_{T}) transmit antennas and multiple (N_{R}) receive antennas for data transmission. A MIMO channel formed by the N_{T} transmit and N_{R} receive antennas can be decomposed into N_{S} independent channels, which can be referred to as spatial channels, where N_{S}≦{N_{T}, N_{R}}.Each of the N_{S} independent channels corresponds to a dimension. Moreover, MIMO systems can provide improved performance (e.g., increased spectral efficiency, higher throughput and/or greater reliability) if the additional dimensionalities created by the multiple transmit and receive antennas are utilized.

MIMO systems can support various duplexing techniques to divide forward and reverse link communications over a common physical medium. For instance, frequency division duplex (FDD) systems can utilize disparate frequency regions for forward and reverse link communications. Further, in time division duplex (TDD) systems, forward and reverse link communications can employ a common frequency region so that the reciprocity principle allows estimation of the forward link channel from reverse link channel.

Wireless communication systems oftentimes employ one or more BSs to provide a coverage area. A typical BS can transmit multiple data streams for broadcast, multicast and/or unicast services, wherein a data stream may be a stream of data that can be of independent reception interest to an AT. An AT within the coverage area of such BS can be employed to receive one, more than one, or all the data streams carried by the composite stream. Likewise, an AT can transmit data to the BS or to another AT.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating buffer status report robustness (BSR) over a UL. An example of an approach for facilitating robustness includes re-transmission of the BSR over a Medium Access Control (MAC) Hybrid Automatic Repeat Request (HARQ) layer if data conditions are met. Examples of data conditions can include: whether a selected amount of time since transmission of the BSR has elapsed, and whether an authorization to transmit data buffered at the AT has been received from the BS. Another example of data conditions can include: whether a selected amount of time since transmission of the BSR has elapsed; whether an authorization to transmit data buffered at the AT has been received from the BS; and whether data is buffered at the AT for transmission.

According to related aspects, a method that facilitates BSR robustness is described herein. The method can include transmitting a BSR. The method can also include tracking an amount of time since transmitting the BSR. Further, the method can include determining, after a selected amount of time has elapsed since transmitting the BSR, whether information indicative of authorization to transmit buffered data has been received. Additionally, the method can include re-transmitting the BSR if the selected amount of time has elapsed and a data condition has been met. In some embodiments, the data condition is that information indicative of authorization to transmit buffered data has not been received. In some embodiments, the method further includes determining, after a selected amount of time since transmitting the BSR, whether data is buffered for transmission, and the data condition is that information indicative of authorization to transmit buffered data has not been received, and a determination has been made that data is buffered for transmission.

Another aspect relates to a computer program product including a computer-readable medium. The computer-readable medium can include code for transmitting a BSR; and code for tracking an amount of time since transmitting the BSR. The computer-readable medium can also include code for determining, after a selected amount of time since transmitting the BSR, whether information indicative of authorization to transmit buffered data has been received. The computer-readable medium can also include code for re-transmitting the BSR if the selected amount of time has elapsed and a data condition has been met.

Yet another aspect relates to an apparatus that facilitates BSR robustness. The apparatus can include a buffer module configured to store buffered data; a controller module configured to generate a BSR indicative of an amount of the buffered data; and a transmitter module configured to transmit the BSR. The apparatus can also include a receiver module configured to receive information indicative of an authorization to transmit the buffered data; and a timer module configured to expire after a selected amount of time since transmission of the BSR has elapsed. The controller module can also be configured to determine, after expiration of the timer module, whether the information indicative of the authorization to transmit the buffered data has been received. The transmitter module can also be configured to re-transmit the BSR if a data condition has been met after expiration of the timer module.

Still another aspect relates to another apparatus that facilitates BSR robustness. The apparatus can include: means for buffering data; means for generating a BSR indicative of an amount of buffered data in the means for buffering data; and means for transmitting the buffer status report. The apparatus can also include: means for receiving information indicative of an authorization to transmit the buffered data, and means for timing an amount of time since transmission of the BSR and expiring after a selected amount of time. The means for generating can also be for determining, after expiration of the means for timing, whether the information indicative of the authorization to transmit the buffered data has been received. The means for transmitting can also be for re-transmitting the BSR if a data condition has been met after expiration of the means for timing.

Yet another aspect relates to a method that facilitates BSR robustness. The method can include: receiving a BSR re-transmitted from an access terminal; and transmitting information to the access terminal indicative of an authorization to transmit the data, in response to receiving the re-transmitted BSR and determining that a required amount of data is buffered for transmission. In this method, the BSR can be re-transmitted from the access terminal after a selected amount of time since the access terminal transmitted an initial BSR and when data conditions are met. In some embodiments, the data condition can include: the information indicative of the authorization to transmit the data has not been received by the access terminal, and a determination by the access terminal has been made that data is buffered for transmission. In some embodiments, the data condition can include: the information indicative of the authorization to transmit the data has not been received by the access terminal.

Still other aspects relate to a computer program product including a computer-readable medium. The computer-readable medium can include: code for receiving a BSR re-transmitted from an access terminal; and code for transmitting information to the access terminal indicative of an authorization to transmit the data, in response to receiving the re-transmitted BSR and determining that a required amount of data is buffered for transmission. The BSR can be re-transmitted from the access terminal after a selected amount of time since the access terminal transmitted an initial BSR and when data conditions are met.

Yet other aspects relate to an apparatus that facilitates BSR robustness. The apparatus can include: a transmitter module configured to transmit information indicative of an authorization to transmit data buffered at an access terminal. The apparatus can also include: a receiver module configured to receive a BSR re-transmitted from the access terminal after a selected amount of time since the access terminal transmitted an initial BSR and when data conditions are met. The apparatus can also include: a controller module configured to: evaluate the BSR re-transmitted from the access terminal; determine whether a required amount of data is buffered at the access terminal for transmission; and in response to determining that a required amount of data is buffered at the access terminal for transmission, control the transmitter module to transmit to the access terminal, the information indicative of the authorization to transmit the data buffered at the access terminal. In some embodiments, the data conditions include: the information indicative of the authorization to transmit the data has not been received by the access terminal, and a determination by the access terminal has been made that data is buffered at the access terminal for transmission. In some embodiments, the data conditions include: the information indicative of the authorization to transmit the data has not been received by the access terminal.

Other aspects relate to an apparatus that facilitates BSR robustness. The apparatus can include: means for transmitting information indicative of an authorization to transmit data buffered at a user communication means. The apparatus can also include: means for receiving a BSR re-transmitted from the user communication means after a selected amount of time since the user communication means transmitted an initial BSR and when data conditions are met. The apparatus can also include: means for controlling configured to: evaluate the BSR re-transmitted from the user communication means; determine whether a required amount of data is buffered at the user communication means for transmission; and control the means for transmitting to transmit to the user communication means, the information indicative of the authorization to transmit the data buffered at the user communication means, in response to determining that a required amount of data is buffered at the user communication means for transmission. In some embodiments, the data conditions can include: the information indicative of the authorization to transmit the data has not been received by the user communication means, and a determination by the user communication means has been made that data is buffered at the user communication means for transmission. In some embodiments, the data conditions can include: the information indicative of the authorization to transmit the data has not been received by the user communication means.

Still other aspects relate to a system for facilitating BSR robustness. The system includes a wireless communication channel; and a base station configured to communicate over the wireless communication channel. The system also includes an access terminal configured to transmit and re-transmit to the base station over the wireless communication channel. The access terminal includes: a buffer module configured to store buffered data; a first controller module configured to generate a BSR indicative of an amount of the buffered data; and a first transmitter module configured to transmit the BSR to the base station. The access terminal also includes: a first receiver module configured to receive from the base station information indicative of an authorization to transmit the buffered data; and a timer module configured to expire after a selected amount of time since transmission of the BSR to the base station. The first controller module can also be configured to determine, after expiration of the timer module, whether the information indicative of the authorization to transmit the buffered data has been received. The first transmitter module can also be configured to re-transmit the BSR if a data condition has been met after expiration of the timer module.

Finally, other aspects relate to a method that facilitates BSR robustness. The method includes: transmitting a BSR; and tracking an amount of time elapsed since transmitting the BSR. The method also includes: determining, after a selected amount of time has elapsed since transmitting the BSR, whether information indicative of authorization to transmit buffered data has been received; and re-transmitting the BSR if the selected amount of time has elapsed and a data condition has been met. The method also includes: receiving the BSR re-transmitted from an access terminal; and in response to receiving the re-transmitted BSR and determining that a required amount of data is buffered for transmission, transmitting the information to the access terminal indicative of an authorization to transmit the data.

Toward the accomplishment of the foregoing and related ends, the one or more embodiments comprise the features hereinafter fully described and particularly pointed out in the claims. The following description and the annexed drawings set forth herein detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of an example wireless communication system for facilitating BSR robustness in accordance with various aspects set forth herein.

FIG. 2 is an illustration of an example of another wireless communication system for facilitating BSR robustness in accordance with various aspects set forth herein.

FIG. 3 is an example of a flowchart of a method for facilitating BSR robustness in accordance with various aspects set forth herein.

FIG. 4 is an illustration of an example of a block diagram of an access terminal for facilitating BSR robustness in accordance with various aspects set forth herein.

FIG. 5 is an illustration of an example of a block diagram of a system for facilitating BSR robustness in accordance with various aspects set forth herein.

FIG. 6 is an example of a flowchart of a method for facilitating BSR robustness in accordance with various aspects set forth herein.

FIG. 7 is an illustration of an example of a block diagram of a base station for facilitating BSR robustness in accordance with various aspects set forth herein.

FIG. 8 is an illustration of an example of a block diagram of a system for facilitating BSR robustness in accordance with various aspects set forth herein.

FIG. 9 is an example of a flowchart of a method for facilitating BSR robustness in accordance with various aspects set forth herein.

FIG. 10 is an illustration of an example wireless network environment that can be employed in conjunction with the various systems, methods or apparatus described herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiments may be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software and/or software in execution. For example, a component can be, but is not limited to being, a process running on a processor, a processor, an object, an executable, a thread of execution, a program, and/or a computer. By way of illustration, both an application running on a computing device and/or the computing device can be a component. One or more components can reside within a process and/or thread of execution and a component can be localized on one computer and/or distributed between two or more computers. In addition, these components can execute from various computer-readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA) and/or other systems. The terms “system” and “network” are often used interchangeably. A CDMA system can implement a radio technology such as Universal Terrestrial Radio Access (UTRA), CDMA1220, etc. UTRA includes Wideband-CDMA (W-CDMA) and other variants of CDMA. CDMA1220 covers IS-1220, IS-95 and IS-856 standards. An OFDMA system can implement a radio technology such as Evolved UTRA (E-UTRA), Ultra Mobile Broadband (UMB), IEEE 122.11 (Wi-Fi), IEEE 122.16 (WiMAX), IEEE 122.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA1220 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 122.xx wireless LAN, BLUETOOTH and any other short- or long-range, wireless communication techniques.

Single carrier frequency division multiple access (SC-FDMA) utilizes single carrier modulation and frequency domain equalization. SC-FDMA can have similar performance and essentially the same overall complexity as those of an OFDMA system. A SC-FDMA signal can have lower peak-to-average power ratio (PAPR) because of its inherent single carrier structure. SC-FDMA can be used, for instance, in uplink communications where lower PAPR greatly benefits ATs in terms of transmit power efficiency. Accordingly, SC-FDMA can be implemented as an uplink multiple access scheme in 3GPP Long Term Evolution (LTE) or Evolved UTRA.

Furthermore, various embodiments are described herein in connection with an AT. An AT can also be called a system, subscriber unit, subscriber station, mobile station, mobile, remote station, remote terminal, mobile device, user terminal, terminal, wireless communication device, user agent, user device or user equipment (UE). An AT can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a BS. A BS can be utilized for communicating with ATs and can also be referred to as an access point, Node B, Evolved Node B (eNodeB, eNB) or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include, but are not limited to, magnetic storage devices (e.g., hard disk, floppy disk, magnetic strips), optical disks (e.g., compact disk (CD), digital versatile disk (DVD)), smart cards, and flash memory devices (e.g., EPROM, card, stick, key drive). Additionally, various storage media described herein can represent one or more devices and/or other machine-readable media for storing information. The term “machine-readable medium” can include, without being limited to, wireless channels and various other media capable of storing, containing, and/or carrying codes and/or instruction(s) and/or data.

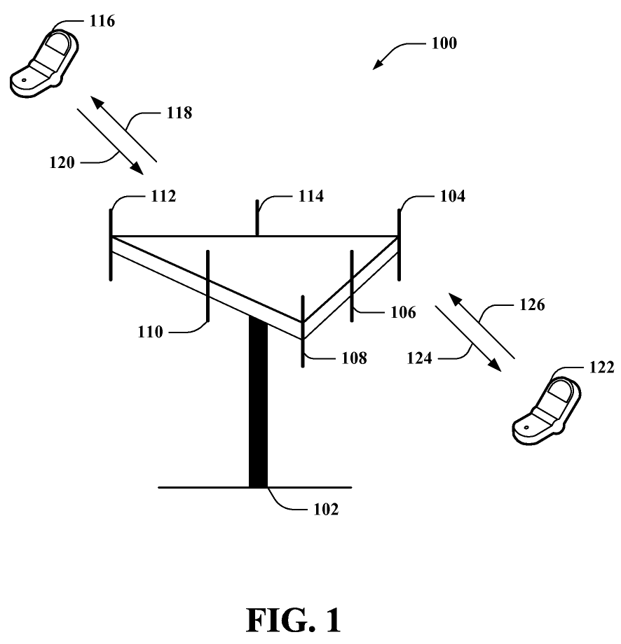

Referring now to FIG. 1, a wireless communication system 100 is illustrated in accordance with various embodiments presented herein. System 100 includes a BS 102 that can include multiple antenna groups. For example, one antenna group can include antennas 104, 106, another group can comprise antennas 108, 110, and an additional group can include antennas 112, 114. Two antennas are illustrated for each antenna group; however, more or fewer antennas can be utilized for each group. BS 102 can additionally include a transmitter chain and a receiver chain, each of which can in turn comprise a plurality of components associated with signal transmission and reception (e.g., processors, modulators, multiplexers, demodulators, demultiplexers, antennas), as will be appreciated by one skilled in the art.

BS 102 can communicate with one or more ATs such as AT 116, 122. However, it is to be appreciated that BS 102 can communicate with substantially any number of ATs similar to ATs 116, 122. ATs 116, 122 can be, for example, cellular phones, smart phones, laptops, handheld communication devices, handheld computing devices, satellite radios, global positioning systems, PDAs, and/or any other suitable device for communicating over wireless communication system 100. As depicted, AT 116 is in communication with antennas 112, 114, where antennas 112, 114 transmit information to AT 116 over DL 118 and receive information from AT 116 over a UL 120. Moreover, AT 122 is in communication with antennas 104, 106, where antennas 104, 106 transmit information to AT 122 over a DL 124 and receive information from AT 122 over a UL 126. In a frequency division duplex (FDD) system, DL 118 can utilize a different frequency band than that used by UL 120, and DL 124 can employ a different frequency band than that employed by UL 126, for example. Further, in a time division duplex (TDD) system, DL 118 and UL 120 can utilize a common frequency band and DL 124 and UL 126 can utilize a common frequency band.

Each group of antennas and/or the area in which they are designated to communicate can be referred to as a sector of BS 102. For example, antenna groups can be designed to communicate to ATs in a sector of the areas covered by BS 102. In communication over DLs 118, 124, the transmitting antennas of BS 102 can utilize beamforming to improve signal-to-noise ratio of DLs 118, 124 for ATs 116, 122. Also, while BS 102 utilizes beamforming to transmit to ATs 116, 122 scattered randomly through an associated coverage, ATs 116, 122 in neighboring cells can be subject to less interference as compared to a BS transmitting through a single antenna to all its ATs.

Additionally, system 100 can facilitate BSR robustness by providing transmission and, in some embodiments, re-transmission of a BSR (not shown) over UL 126 from AT 122 to BS 102 based on data conditions. Embodiments of the AT 122, 122′, 122″ and BS 102, 102′, 102″, systems, methods, computer program products and means for facilitating BSR robustness will be described in further detail below.

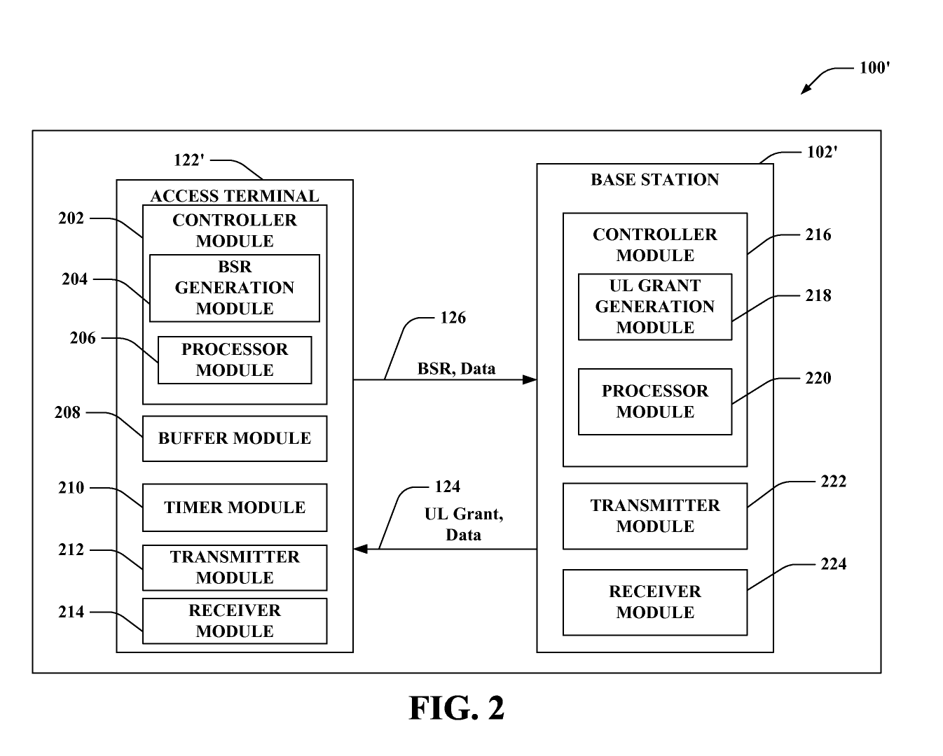

FIG. 2 is an illustration of an example of a block diagram of another wireless communication system for facilitating BSR robustness in accordance with various aspects set forth herein. The system 100′ can include an AT 122′ communicatively coupled to a BS 102′ via a UL 126 and a DL 124. The AT 122′ can transmit information, including, but not limited to, a BSR or data, over the UL 126. The BS can transmit information, including, but not limited to, a UL grant or data, over the DL 124. In embodiments, the AT 122′ can be configured to re-transmit the BSR over the UL 126 under various data conditions in order to facilitate BSR robustness in the system 100′.

In some embodiments, the AT 122′ can include a controller module 202, a BSR generation module 204, a processor module 206, a buffer module 208, a timer module 210, a transmitter module 212 and/or a receiver module 214. In various embodiments, one or more of the aforementioned modules can be communicatively coupled to one another to facilitate BSR robustness.

The buffer module 208 can be configured to store buffered data at the AT 122′. The buffered data can be data for transmission on the UL 126. For example, in various embodiments, the data can include, but is not limited to, voice, video and/or internet data.

The controller module 202 can include a BSR generation module 204 configured to generate information indicative of an amount of the buffered data in the buffer module 208. In some embodiments, the information indicative of the amount of the buffered data can be (or can be included within) a BSR. The BSR can be included in a MAC control element, and the MAC control element can be included in a MAC packet data unit (PDU).

In various embodiments, the BSR can be transmitted from the AT 122′ to the BS 102′ on the MAC HARQ layer (not shown) of system 100′. However, if the BSR is not successfully received or able to be read at the BS 102′ (due to channel conditions, errors or otherwise), the AT 122′ may not receive notification of the lost BSR. Because the AT 122′ awaits receipt of the UL grant prior to transmitting the data from the AT 122′, and the UL grant is transmitted after receipt of the BSR by the BS, the AT 122′ can be prevented from transmitting data if the BSR is lost. In such cases, the controller module 202 can generate a new BSR in the BSR generation module 204 and re-transmit the BSR to facilitate robustness of the BSR.

Referring back to FIG. 2, in some embodiments, the controller module 202 also includes a processor module 206 including general or specialized hardware, general or specialized software or a combination thereof for performing any of the method steps and/or functions described herein. In some embodiments, the processor module 206 can include functionality for executing code and/or instructions stored on a computer-readable medium.

The timer module 210 can be configured for tracking an amount of time since a BSR has been transmitted from the AT 122′. The timer module 210 can be configured to expire after a selected amount of time since transmission of the BSR. In some embodiments, the timer module 816 can be configured by the BS 102′.

In particular, the timer module 210 can include one or more different types of timer modules for tracking an amount of time since the BSR has been transmitted from the AT. The type of timer module that tracks the amount of time and/or the selected amount of time before the selected timer module expires can be configured by the BS 102′. For example, the selected timer module and the selected amount of time before the selected timer module expires can be configured while the AT 122′ is conducting a telephone call or any other type of communication and/or data transfer.

The transmitter module 212 can be configured to transmit the BSR to the BS 102′. The transmitter module 212 can also be configured to re-transmit the BSR if a data condition has been met after expiration of the timer module 210.

The receiver module 214 can be configured to receive from the BS 102′ information indicative of an authorization to transmit the buffered data. In embodiments, the information indicative of the authorization to transmit the buffered data can be the UL grant.

Referring to the BS 102′, the BS 102′ can include a controller module 216, a transmitter module 222 and a receiver module 224. The controller module 216 can include a UL grant generation module 218 and/or a processor module 220. The UL grant generation module 218 can include general or specialized hardware, software and/or a combination of general or specialized hardware and software for generating a UL grant for transmission by the transmitter module 222 to the AT 122′ upon receipt of the BSR by the receiver module 224. In some embodiments, the BS 102′ receives the BSR with the receiver module 224 and evaluates the amount of data buffered at the AT 122′. The BS 102′ then transmits the UL grant to the AT 122′ if the amount of data buffered meets a minimum required amount of data.

If controller module 216 of the BS 102′ determines that a sufficient amount of data is buffered at the AT, the controller module 216 can control the UL grant generation module 218 to generate information indicative of the authorization to transmit data. The transmitter module 222 can be configured to transmit the information indicative of the authorization to transmit the data buffered at the AT 122′. The information indicative of the authorization to transmit the data can be the UL grant.

The BS 102′ can also configure the selected timer module (not shown) in the timer module 210, and/or the selected amount of time before the timer module (not shown) expires, in some embodiments. In particular, the Radio Resource Control (RRC) (not shown) of the system 100′ can configure the timer module. The RRC can also configure, for each logical channel (not shown) on which the AT 122′ can communicate, signaling that allocates the logical channel to a Logical Channel Group (LCG). By way of example, but not limitation, referring to 3GPP TS 36.321 v8.6.0 (2009-06), “3rd Generation Partnership Project; Technical Specification Group Radio Access Network; Evolved Universal Terrestrial Radio Access (E-UTRA) Medium Access Control (MAC) Protocol Specification (Release 8),” (TS 36.321 v8.6.0 Specification), for each logical channel, the RRC can configure the logicalChannelGroup parameter for allocating the logical channel to an LCG.

Referring back to the BSR generation module 204 and/or the processor module 206, the AT 122′ can be controlled to trigger generation of the BSR in a limited number of circumstances. Referring to the TS 36.321 v8.6.0 Specification, 3GPP TS 36.322: “Evolved Universal Terrestrial Radio Access (E-UTRA); Radio Link Control (RLC) protocol specification,” (TS 36.322 Specification) and the 3GPP TS 36.323: “Evolved Universal Terrestrial Radio Access (E-UTRA); Packet Data Convergence Protocol (PDCP) Specification,” (TS 36.323 Specification), triggering the generation of the BSR at the BSR generation module 204 and/or the processor module 206 can occur if any of the following events occur.

First, a BSR can be triggered for generation by the BSR generation module 204 if the timer module 210 expires. The timer module 210 can be started (or re-started) when the BSR is transmitted by the transmitter module 212 from the AT 122′. The timer module can expire after a selected amount of time.

In particular, the controller module 202 can be configured to determine, after expiration of the timer module 210, whether the information indicative of the authorization to transmit the buffered data has been received from the BS 102′ and a data condition is met. In some embodiments, a data condition can be that the receiver module 214 at the AT 122′ has not received the information indicative of authorization to transmit the buffered data. With reference to the TS 36.321 v8.6.0 Specification, the timer module can be the timer module 210 referred to as periodicBSR-Timer and the BSR can be the BSR referred to as the Periodic BSR.

Second, in some embodiments, the controller module 202 is further configured to determine, after expiration of the timer module 210, whether the buffer module 208 is storing buffered data. In these embodiments, the data condition for re-transmitting a BSR can be that the receiver module 214 at the AT 122′ has not received the information indicative of authorization to transmit the buffered data, and the controller module 202 has determined that the buffer module 208 is storing buffered data.

In these embodiments, the timer module 210 can be started (or re-started) when the BSR is transmitted by the transmitter module 212 from the AT 122′. The timer module 210 can expire after a selected amount of time. In some embodiments, with reference to the TS 36.321 v8.6.0 Specification, the data available can be data available for transmission for any of the logical channels that belong to an LCG. Further, the timer module 210 can be the timer module referred to as retxBSR-Timer and the BSR can be the BSR referred to as the Regular BSR.

Third, the controller module 202 can be configured to generate a BSR if the UL data, for a logical channel that belongs to a LCG, becomes available for transmission in the Radio Link Control (RLC) entity (not shown) or in the Packet Data Convergence Protocol (PDCP) entity (not shown), and either the data belongs to a logical channel with higher priority than the priorities of the logical channels that belong to any LCG and for which data is already available for transmission, or there is no data available for transmission for any of the logical channels that belong to a LCG. In this embodiment, the BSR can be the BSR referred to as a Regular BSR.

Fourth, the controller module 202 can be configured to generate a BSR if UL resources are allocated and a number of padding bits is equal to or larger than the size of a BSR MAC control element in combination with the subheader of the BSR MAC control element. In this embodiment, the BSR can be the BSR referred to as a Padding BSR.

In some embodiments, if the controller module 202 determines that at least one BSR has been triggered since the last transmission of the BSR or if it is the first time that the BSR is triggered, the controller module 202 can perform a number of steps. By way of example, but not limitation, if the AT 122′ has UL resources allocated for a new transmission, the BSR generation module 204 can generate a BSR in a MAC control element and start (or re-start) a selected one of the timer modules in timer module 210. For example, with reference to the TS 36.321 v8.6.0 Specification, the periodicBSR-Timer timer module can be started (or re-started) except when the BSR is a Truncated BSR, as defined in the TS 36.321 v8.6.0 Specification. In other embodiments, the retxBSR-Timer timer module can be started (or re-started). Further, if a Regular (not Truncated) BSR is triggered, a Scheduling Request can be triggered.

In various embodiments, the MAC PDU can include at most one BSR MAC control element, even when multiple events trigger the generation of the BSR. In these embodiments, with reference to the TS 36.321 v8.6.0 Specification, the Regular BSR and the Periodic BSR can have precedence over the Padding BSR.

The timer module 210 can restart its timer upon receipt of the UL grant at the receiver module 214. With reference to the TS 36.321 v8.6.0 Specification, the retxBSR-Timer timer module can be re-started upon indication of receipt of the UL grant.

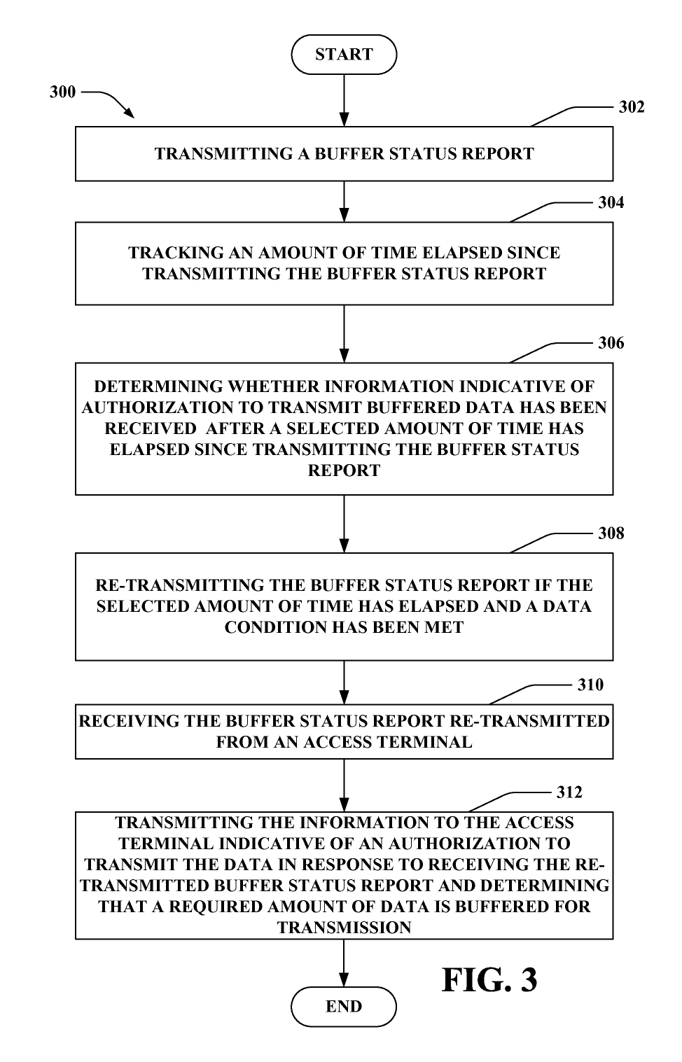

FIG. 3 is an exemplary flowchart of a method for facilitating BSR robustness in accordance with various aspects set forth herein. In embodiments, method 300 can include transmitting a BSR 302. The BSR can be included in a MAC control element. The transmitting and/or the re-transmitting of the BSR can be on the MAC HARQ layer.

The method 300 can also include tracking an amount of time elapsed since transmitting the BSR 304. The method 300 can also include determining whether information indicative of authorization to transmit buffered data has been received, after a selected amount of time since transmitting the BSR 306. The information indicative of authorization to transmit the data can be a UL grant. The UL grant can be transmitted on a paging channel or a random access channel.

The method 300 can also include re-transmitting the BSR if the selected amount of time has elapsed and a data condition has been met 308. The method 300 can also include receiving the BSR re-transmitted from an AT 310. The method 300 can also include, in response to receiving the re-transmitted BSR and determining that a required amount of data is buffered for transmission, transmitting the information to the AT indicative of an authorization to transmit the data 312. In some embodiments, the data condition is that the receiver module has not received the information indicative of authorization to transmit the buffered data.

In some embodiments, method 300 also includes transmitting configuration information for determining the data condition to the access terminal (not shown). In some embodiments, method 300 also includes transmitting configuration information indicative of the selected amount of time to the access terminal (not shown).

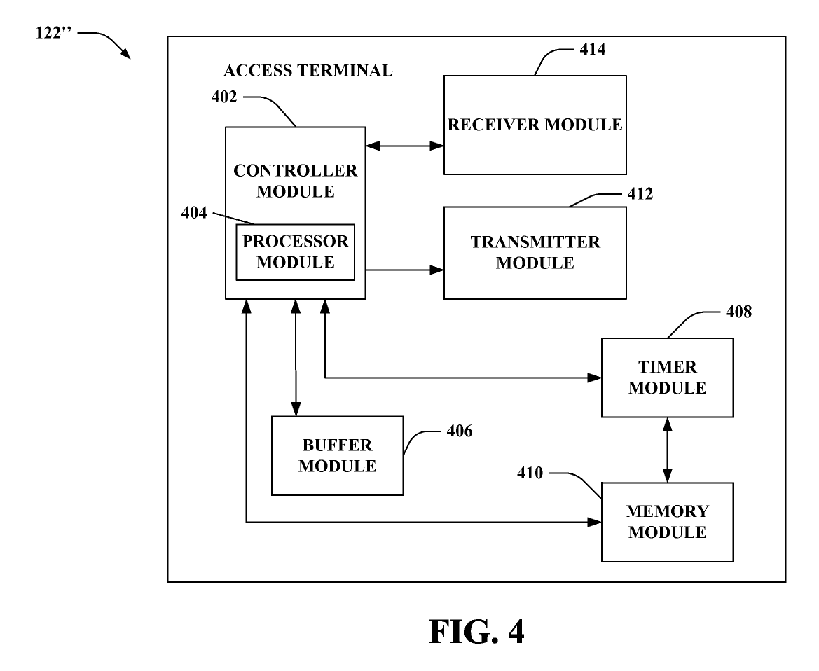

FIG. 4 is an illustration of an example of a block diagram of an AT for facilitating BSR robustness in accordance with various aspects set forth herein. The AT 122″ can include a controller module 402, a processor module 404, a buffer module 406, a timer module 408, a memory module 410, a transmitter module 412 and a receiver module 414. The controller module 402, processor module 404, buffer module 406, timer module 408, memory module 410, transmitter module 412 and/or receiver module 414 can be communicatively coupled to one another to facilitate BSR robustness.

The buffer module 406 can be configured to store buffered data. The controller module 402 can be configured to generate a BSR indicative of an amount of the buffered data. The controller module 402 can also be configured to determine, after expiration of the timer module 408, whether the information indicative of the authorization to transmit the buffered data has been received. In some embodiments, the controller module 402 can be further configured to determine, after expiration of the timer module 408, whether the buffer module 406 is storing buffered data, and wherein the data condition is that the receiver module 414 has not received the information indicative of authorization to transmit the buffered data, and the controller module 402 has determined that the buffer module 406 is storing buffered data.

The transmitter module 412 can be configured to transmit the BSR. The receiver module 414 can be configured to receive information indicative of an authorization to transmit the buffered data. The transmitter module can also be configured to re-transmit the BSR if a data condition has been met after expiration of the timer module 408.

The timer module 408 can be configured to expire after a selected amount of time since transmission of the BSR has elapsed. In some embodiments, the timer module 408 can be configured by a BS (not shown) to which the AT 122″ is communicatively coupled. In some embodiments, the timer module 408 is one of a number of timer modules in the AT 122, and the timer module 408 can be selected, and the selected amount of time can be determined, based on configuration information received at the AT 122.

In some embodiments, the data condition can be that the receiver module 414 has not received the information indicative of authorization to transmit the buffered data.

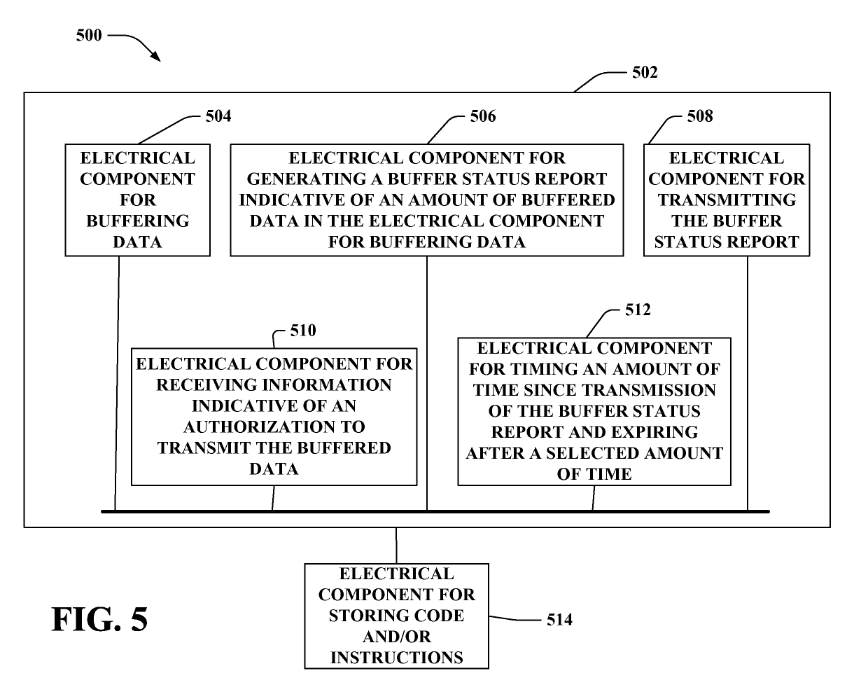

With reference to FIG. 5, illustrated is a system that facilitates BSR robustness. For example, system 500 can reside within an AT. It is to be appreciated that system 500 is represented as including functional blocks, which can be functional blocks that represent functions implemented by a processor, hardware, software, firmware, or combination thereof. System 500 can include a logical grouping 502 of electrical components that can act in conjunction. For instance, logical grouping 502 can include an electrical component for buffering data 504. In some embodiments, the electrical component for buffering data 504 can include, but is not limited to, a buffer, queue or buffer module of 406 described with reference to FIG. 4.

Further, logical grouping 502 can include an electrical component for generating a BSR indicative of an amount of buffered data in the electrical component for buffering data 506. In some embodiments, the electrical component for generating a BSR indicative of an amount of buffered data in the electrical component for buffering data 506 can include, but is not limited to, a controller, processor and/or controller module of 402 or processor module 404 described with reference to FIG. 4.

Moreover, logical grouping 502 can include an electrical component for transmitting the BSR 508. In some embodiments, the electrical component for transmitting the BSR 508 can include, but is not limited to, a transmitter, transceiver or the transmitter module 412 described with reference to FIG. 4.

Additionally, logical component 502 can include an electrical component for receiving information indicative of an authorization to transmit the buffered data 510. In some embodiments, the electrical component for receiving information indicative of an authorization to transmit the buffered data 510 can include, but is not limited to, a receiver, transceiver or the receiver module 414 described with reference to FIG. 4.

Further, logical component 502 can an electrical component for timing an amount of time since transmission of the BSR and expiring after a selected amount of time 512. The electrical component for timing can be configured by an electrical component for communication to which the system 500 is communicatively coupled. In some embodiments, the electrical component for timing an amount of time since transmission of the BSR and expiring after a selected amount of time 512 can include, but is not limited to, a timer, clock or the timer module 408 described with reference to FIG. 4. The electrical component 512 for timing can be configured by an electrical component for communication to which the system 500 is communicatively coupled.

Additionally, the system 500 can include an electrical component 514 for storing code and/or instructions for executing functions associated with electrical components 504, 506, 508, 510 and/or 512. The electrical component 514 can include, but is not limited to, a memory, a computer-readable medium and/or the memory module 410 described with reference to FIG. 4. While shown as being external to the electrical component for storing 514, it is to be understood that one or more of electrical components 504, 506, 508, 510 and/or 512 can be included within the electrical component for storing 514.

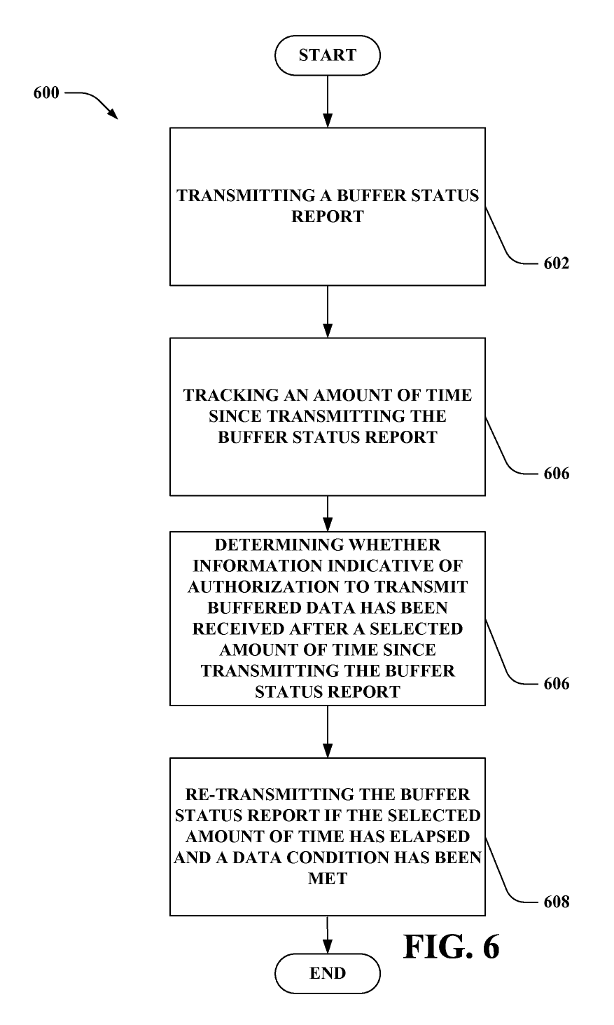

FIG. 6 is an exemplary flowchart of a method for facilitating BSR robustness in accordance with various aspects set forth herein. The method 600 can include transmitting a BSR 602. In some embodiments, the BSR can be transmitted on the MAC HARQ layer. The BSR can be transmitted from an AT to a BS to communicate an amount of data buffered at the AT for UL transmission.

The method 600 can also include tracking an amount of time since transmitting the BSR 604. In various embodiments, the amount of time can be initialized at a value of zero (or any other initial value) at the time of transmission. The amount of time can increase in regular increments until a UL grant is received from the BS, until a selected amount of time has elapsed since transmission of the BSR or until an expiration of a timer module that can track the amount of time since transmitting the BSR.

The method 600 can also include determining, after a selected amount of time since transmitting the BSR, whether information indicative of authorization to transmit buffered data has been received 606. In some embodiments, the information indicative of authorization to transmit the buffered data can be a UL grant or any other information having indicia of authorization to transmit data. The UL grant or other information can be received at the AT and, as such, the AT can determine whether it has received the UL grant or any other information authorizing transmission of data.

The method 600 can also include re-transmitting the BSR if the selected amount of time has elapsed and a data condition has been met 608. In these embodiments, the data condition can be that information indicative of authorization to transmit the buffered data has not been received. In various embodiments, transmitting and/or re-transmitting the BSR are on the MAC HARQ layer.

The method can also include receiving configuration information indicative of the selected amount of time and/or receiving configuration information for determining the data condition.

In some embodiments, the method 600 can further include determining, after the selected amount of time has elapsed since transmitting the information, whether data is buffered for transmission (not shown). In these embodiments, the data condition can be that information indicative of authorization to transmit the buffered data has not been received, and a determination has been made that data is buffered for transmission. In various embodiments, transmitting and/or re-transmitting the BSR are on the MAC HARQ layer.

One or more aspects described herein can be performed via a computer program product. The computer program product can include a computer-readable medium. The computer-readable medium can include code for transmitting a BSR. The computer-readable medium can also include code for tracking an amount of time elapsed since transmitting the BSR. The computer-readable medium can also include code for determining, after a selected amount of time has elapsed since transmitting the BSR, whether information indicative of authorization to transmit buffered data has been received. The computer-readable medium can also include code for re-transmitting the BSR if the selected amount of time has elapsed and a data condition has been met. The data condition can be that information indicative of authorization to transmit the buffered data has not been received.

The computer program product can also include code for determining, after the selected amount of time has elapsed since transmitting the information, whether data is buffered for transmission. In these embodiments, the data condition can be that information indicative of authorization to transmit the buffered data has not been received, and a determination has been made that data is buffered for transmission.

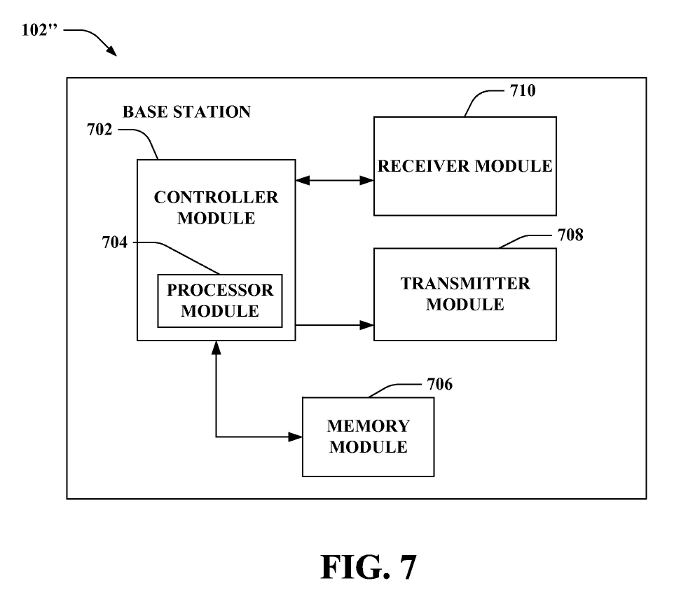

FIG. 7 is an illustration of an example of a block diagram of a BS for facilitating BSR robustness in accordance with various aspects set forth herein. The BS 102″ can include a controller module 702, a processor module 704, a memory module 706, a transmitter module 708, and a receiver module 710. The controller module 702, processor module 704, memory module 706, transmitter module 708, and/or receiver module 710 can be communicatively coupled to one another. In some embodiments, the controller module 702 can include the processor module 704.

In some embodiments, the transmitter module 708 can be configured to transmit information indicative of an authorization to transmit data buffered at an AT (not shown). In some embodiments, the information indicative of authorization to transmit the data can be a UL grant. In other embodiments, the information indicative of authorization to transmit the data can be any information for authorizing transmission of data from the AT.

In some embodiments, the receiver module 710 can be configured to receive a BSR re-transmitted from the AT (not shown) after a selected amount of time since the AT transmitted an initial BSR, and when data conditions are met.

The controller module 702 (and/or the processor module 704) can be configured to evaluate the BSR re-transmitted from the AT to determine whether a required amount of data is buffered at the AT for transmission. The controller module 702 (and/or the processor module 704) can also be configured to control the transmitter module 708 to transmit to the AT, the information indicative of the authorization to transmit the data buffered at the AT, in response to determining that a required amount of data is buffered at the AT for transmission. In some embodiments, the controller module 702 (and/or the processor module 704) can also be configured to configure a timer module (not shown) at an AT to which the BS 102″ is communicatively coupled.

In some embodiments, the data condition can include: the information indicative of the authorization to transmit the data has not been received by the AT, and a determination by the AT has been made that data is buffered at the AT for transmission. In some embodiments, the data condition includes: the information indicative of the authorization to transmit the data has not been received by the AT.

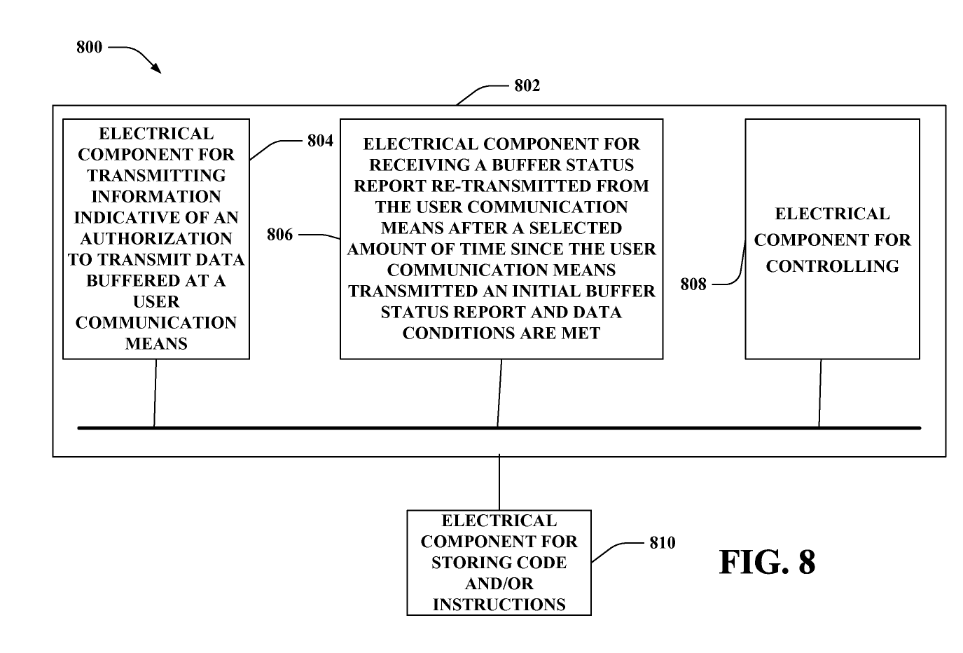

With reference to FIG. 8, illustrated is a system that facilitates BSR robustness. For example, system 800 can reside within a BS. It is to be appreciated that system 800 is represented as including functional blocks, which can be functional blocks that represent functions implemented by a processor, hardware, software, firmware, or combination thereof. System 800 can include a logical grouping 802 of electrical components that can act in conjunction. For instance, logical grouping 802 can include an electrical component for transmitting information indicative of an authorization to transmit data buffered at a user communication means 804. In some embodiments, the electrical component for transmitting information indicative of an authorization to transmit data buffered at a user communication means 804 can include, but is not limited to, an access point (AP), eNB buffer, queue or BS 102, 102′ or 102″. In some embodiments, the user communication means can include, but is not limited to, a UE or an AT, such as the AT 122, 122′, 122″.

Further, logical grouping 802 can include an electrical component for receiving a BSR re-transmitted from the user communication means after a selected amount of time since the user communication means transmitted an initial BSR and when data conditions are met 806. In some embodiments, the electrical component 806 can include, but is not limited to, a receiver and/or a receiver module 710 described with reference to FIG. 7.

Moreover, logical grouping 802 can include an electrical component for controlling 808. The electrical component for controlling 808 can be configured to evaluate the BSR re-transmitted from the user communication means; and determine whether a required amount of data is buffered at the user communication means for transmission. The electrical component for controlling 808 can also be configured to control the electrical component 804 to transmit to the user communication means, the information indicative of the authorization to transmit the data buffered at the user communication means, in response to determining that a required amount of data is buffered at the user communication means for transmission. In some embodiments, the electrical component 808 can include, but is not limited to, a controller, processor and/or the controller module 702 or processor module 704 described with reference to FIG. 7.

Additionally, the system 800 can include an electrical component 810 for storing code and/or instructions for executing functions associated with electrical components 804, 806 and/or 808. The electrical component 810 can include, but is not limited to, a memory, a computer-readable medium and/or the memory module 806 described with reference to FIG. 7. While shown as being external to the electrical component for storing 810, it is to be understood that one or more of electrical components 804, 806 and/or 808 can be included within the electrical component for storing 810.

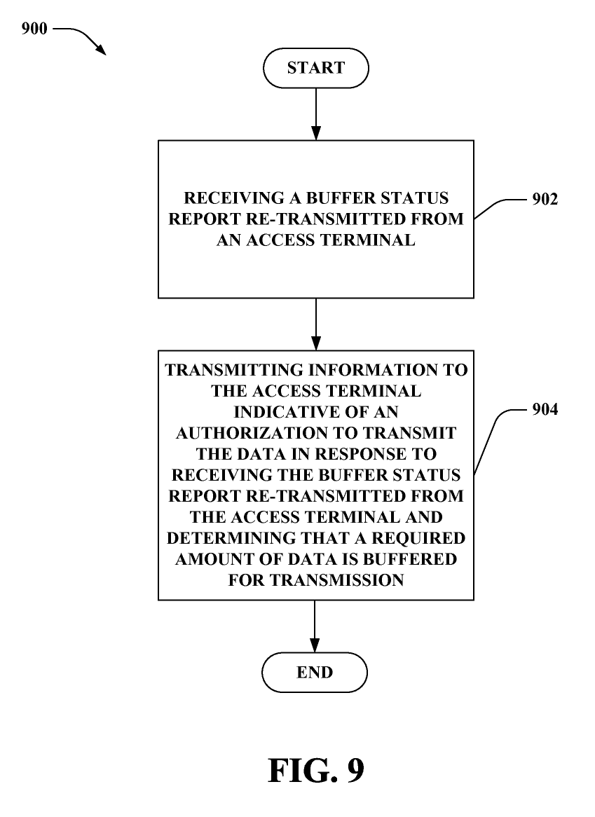

FIG. 9 is an exemplary flowchart of a method for facilitating BSR robustness in accordance with various aspects set forth herein. The method 900 can include receiving a BSR re-transmitted from an AT 902. The method 900 can also include transmitting information to the AT indicative of an authorization to transmit the data, in response to receiving the BSR that is re-transmitted from the AT, and determining that a required amount of data is buffered for transmission 904. The information indicative of authorization to transmit the data can be a UL grant. The BSR can be re-transmitted from the access terminal after a selected amount of time since the access terminal transmitted an initial BSR, and when data conditions are met. The selected amount of time can be a variable having a value configured by the BS at the AT during a call in which the AT participates. The BSR can be re-transmitted from the AT on the MAC HARQ layer.

In some embodiments, the data conditions can include: the information indicative of the authorization to transmit the data has not been received by the access terminal, and a determination by the access terminal has been made that data is buffered for transmission. In some embodiments, the data conditions can include: the information indicative of the authorization to transmit the data has not been received by the access terminal.

The method 900 can also include transmitting configuration information indicative of the selected amount of time and/or for determining the data conditions.

One or more aspects described herein can be performed via a computer program product. The computer program product can include a computer-readable medium. The computer-readable medium can include code for receiving a BSR re-transmitted from an AT. The computer-readable medium can also include code for, in response to receiving the re-transmitted BSR and determining that a required amount of data is buffered for transmission, transmitting information to the AT indicative of an authorization to transmit the data. The BSR can be re-transmitted from the AT after a selected amount of time since the AT transmitted an initial BSR, and when data conditions are met. In some embodiments, the data condition is that information indicative of authorization to transmit the buffered data has not been received.

In some embodiments, the computer-readable medium also includes code for determining, after the selected amount of time since transmitting the information, whether data is buffered for transmission. In these embodiments, the data condition can be that information indicative of authorization to transmit the buffered data has not been received, and a determination has been made that data is buffered for transmission.

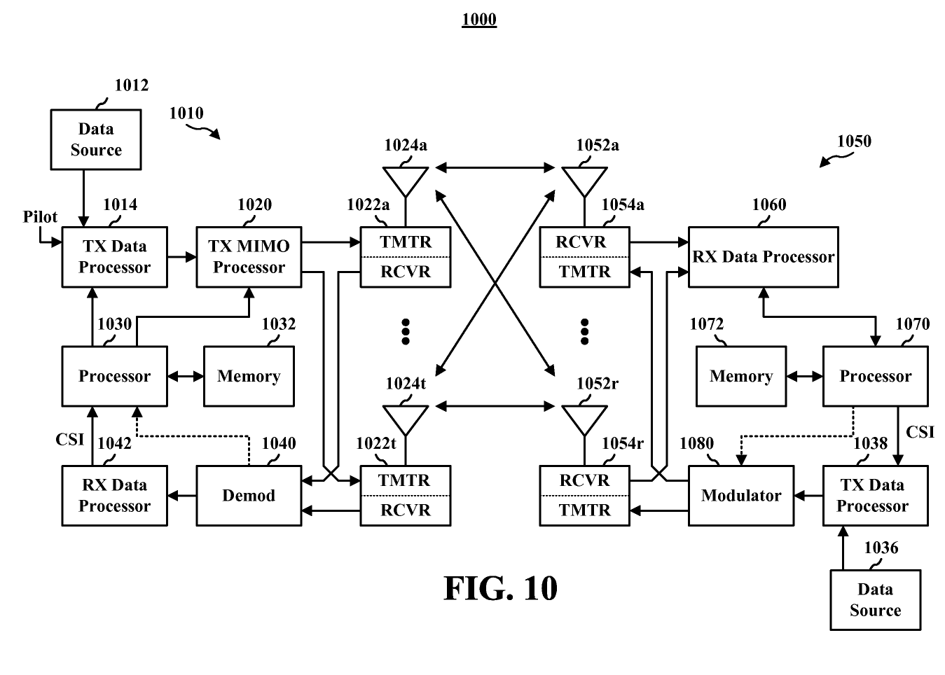

FIG. 10 shows an example wireless communication system 1000. The wireless communication system 1000 depicts one BS 1010 and one AT 1050 for sake of brevity. However, it is to be appreciated that system 1000 can include more than one BS and/or more than one AT, wherein additional BSs and/or ATs can be substantially similar or different from example BS 1010 and AT 1050 described below. In addition, it is to be appreciated that BS 1010 and/or AT 1050 can employ the methods (e.g., FIGS. 3, 6 and/or 9), apparatus (e.g., FIGS. 4 and/or 7) and/or systems (e.g., FIGS. 1, 2, 3, 5 and/or 10) described herein to facilitate wireless communication there between.

At BS 1010, traffic data for a number of data streams is provided from a data source 1012 to a transmit (TX) data processor 1014. According to an example, each data stream can be transmitted over a respective antenna. TX data processor 1014 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at AT 1050 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM)) selected for that data stream to provide modulation symbols. The data rate, coding, and modulation for each data stream can be determined by instructions performed or provided by processor 1030.

The modulation symbols for the data streams can be provided to a TX MIMO processor 1020, which can further process the modulation symbols (e.g., for OFDM). TX MIMO processor 1020 then provides N_{T} modulation symbol streams to N_{T} transmitters (TMTR) 1022a through 1022t. In various embodiments, TX MIMO processor 1020 applies beamforming weights to the symbols of the data streams and to the antenna from which the symbol is being transmitted.

Each transmitter 1022 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1022a through 1022t are transmitted from N_{T} antennas 1024a through 1024t, respectively.

At AT 1050, the transmitted modulated signals are received by N_{R} antennas 1052a through 1052r and the received signal from each antenna 1052 is provided to a respective receiver (RCVR) 1054a through 1054r. Each receiver 1054 conditions (e.g., filters, amplifies, and downconverts) a respective signal, digitizes the conditioned signal to provide samples, and further processes the samples to provide a corresponding “received” symbol stream.

An RX data processor 1060 can receive and process the N_{R} received symbol streams from N_{R} receivers 1054 based on a particular receiver processing technique to provide N_{T} “detected” symbol streams. RX data processor 1060 can demodulate, deinterleave, and decode each detected symbol stream to recover the traffic data for the data stream. The processing by RX data processor 1060 is complementary to that performed by TX MIMO processor 1020 and TX data processor 1014 at BS 1010.

A processor 1070 can periodically determine which available technology to utilize as discussed above. Further, processor 1070 can formulate a reverse link message comprising a matrix index portion and a rank value portion.

The reverse link message can comprise various types of information regarding the communication link and/or the received data stream. The reverse link message can be processed by a TX data processor 1038, which also receives traffic data for a number of data streams from a data source 1036, modulated by a modulator 1080, conditioned by transmitters 1054a through 1054r, and transmitted back to BS 1010.

At BS 1010, the modulated signals from AT 1050 are received by antennas 1024, conditioned by receivers 1022, demodulated by a demodulator 1040, and processed by a RX data processor 1042 to extract the reverse link message transmitted by AT 1050. Further, processor 1030 can process the extracted message to determine which precoding matrix to use for determining the beamforming weights.

Processors 1030 and 1070 can direct (e.g., control, coordinate, manage) operation at BS 1010 and AT 1050, respectively. Respective processors 1030 and 1070 can be associated with memory 1032 and 1072 that store program codes and data. Processors 1030 and 1070 can also perform computations to derive frequency and impulse response estimates for the uplink and downlink, respectively.

In an aspect, logical channels can be classified into Control Channels and Traffic Channels. Logical Control Channels can include a Broadcast Control Channel (BCCH), which is a DL channel for broadcasting system control information. Further, Logical Control Channels can include a Paging Control Channel (PCCH), which is a DL channel that transfers paging information. Moreover, the Logical Control Channels can include a Multicast Control Channel (MCCH), which is a Point-to-multipoint DL channel used for transmitting Multimedia Broadcast and Multicast Service (MBMS) scheduling and control information for one or several Multicast Traffic Channels (MTCHs). Generally, after establishing a Radio Resource Control (RRC) connection, this channel is only used by ATs that receive MBMS (e.g., old MCCH+MSCH). Additionally, the Logical Control Channels can include a Dedicated Control Channel (DCCH), which is a Point-to-point bi-directional channel that transmits dedicated control information and can be used by ATs having a RRC connection. In an aspect, the Logical Traffic Channels can comprise a Dedicated Traffic Channel (DTCH), which is a Point-to-point bi-directional channel dedicated to one AT for the transfer of user information. Also, the Logical Traffic Channels can include an MTCH for Point-to-multipoint DL channel for transmitting traffic data.

In an aspect, Transport Channels are classified into DL and UL. DL Transport Channels can include a Broadcast Channel (BCH), a Downlink Shared Data Channel (DL-SDCH) and a Paging Channel (PCH). The PCH can support AT power saving (e.g., Discontinuous Reception (DRX) cycle can be indicated by the network to the AT) by being broadcasted over an entire cell and being mapped to Physical layer (PHY) resources that can be used for other control/traffic channels. The UL Transport Channels can comprise a Random Access Channel (RACH), a Request Channel (REQCH), an Uplink Shared Data Channel (UL-SDCH) and a plurality of PHY channels.

The PHY channels can include a set of DL channels and UL channels. For example, the DL PHY channels can include: Common Pilot Channel (CPICH); Synchronization Channel (SCH); Common Control Channel (CCCH); Shared DL Control Channel (SDCCH); Multicast Control Channel (MCCH); Shared UL Assignment Channel (SUACH); Acknowledgement Channel (ACKCH); DL Physical Shared Data Channel (DL-PSDCH); UL Power Control Channel (UPCCH); Paging Indicator Channel (PICH); and/or Load Indicator Channel (LICH). By way of further illustration, the UL PHY Channels can include: Physical Random Access Channel (PRACH); Channel Quality Indicator Channel (CQICH); Acknowledgement Channel (ACKCH); Antenna Subset Indicator Channel (ASICH); Shared Request Channel (SREQCH); UL Physical Shared Data Channel (UL-PSDCH); and/or Broadband Pilot Channel (BPICH).

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors and/or other electronic units designed to perform the functions described herein, or a combination thereof.

When the embodiments are implemented in software, firmware, middleware or microcode, program code or code segments, they can be stored in a machine-readable medium (or a computer-readable medium), such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates buffer status report robustness, the method comprising:
transmitting a buffer status report;
tracking an amount of time since transmitting the buffer status report;
determining, after a selected amount of time since transmitting the buffer status report, whether information indicative of authorization to transmit buffered data has been received; and
re-transmitting the buffer status report if the selected amount of time has elapsed and a data condition has been met.

2. The method of claim 1, wherein the data condition is that the information indicative of authorization to transmit the buffered data has not been received.

3. The method of claim 1, further comprising:
determining, after the selected amount of time since transmitting the buffer status report, whether data is buffered for transmission, and
wherein the data condition is that the information indicative of authorization to transmit the buffered data has not been received, and a determination has been made that data is buffered for transmission.

4. The method of claim 1, wherein the information indicative of authorization to transmit the buffered data is an uplink grant.

5. The method of claim 1, wherein transmitting and re-transmitting the buffer status report is on a Medium Access Control (MAC) Hybrid Automatic Repeat Request (HARQ) layer.

6. The method of claim 1, further comprising receiving configuration information indicative of the selected amount of time.

7. The method of claim 1, further comprising receiving configuration information for determining the data condition.

8. A computer program product, comprising:
a computer-readable medium comprising:
code for transmitting a buffer status report;
code for tracking an amount of time since transmitting the buffer status report;
code for determining, after a selected amount of time since transmitting the buffer status report, whether information indicative of authorization to transmit buffered data has been received; and
code for re-transmitting the buffer status report if the selected amount of time has elapsed and a data condition has been met.

9. The computer program product of claim 8, wherein the data condition is that the information indicative of authorization to transmit the buffered data has not been received.

10. The computer program product of claim 8, further comprising:
code for determining, after the selected amount of time since transmitting the buffer status report, whether data is buffered for transmission, and
wherein the data condition is that information indicative of authorization to transmit the buffered data has not been received, and a determination has been made that data is buffered for transmission.

11. An apparatus that facilitates buffer status report robustness, the apparatus comprising:
a buffer module configured to store buffered data;
a controller module configured to generate a buffer status report indicative of an amount of the buffered data;
a transmitter module configured to transmit the buffer status report;
a receiver module configured to receive information indicative of an authorization to transmit the buffered data; and
a timer module configured to expire after a selected amount of time since transmission of the buffer status report,
wherein the controller module is also configured to determine, after expiration of the timer module, whether the information indicative of the authorization to transmit the buffered data has been received, and
wherein the transmitter module is also configured to re-transmit the buffer status report if a data condition has been met after expiration of the timer module.

12. The apparatus of claim 11, wherein the data condition is that the receiver module has not received the information indicative of authorization to transmit the buffered data.

13. The apparatus of claim 11, wherein the controller module is further configured to determine, after expiration of the timer module, whether the buffer module is storing buffered data, and wherein the data condition is that the receiver module has not received the information indicative of authorization to transmit the buffered data, and the controller module has determined that the buffer module is storing buffered data.

14. The apparatus of claim 11, wherein the timer module is one of a plurality of timer modules, and the timer module is selected, and the selected amount of time is determined, based on configuration information received at the apparatus.

15. An apparatus that facilitates buffer status report robustness, the apparatus comprising:
means for buffering data;
means for generating a buffer status report indicative of an amount of buffered data in the means for buffering data;
means for transmitting the buffer status report;
means for receiving information indicative of an authorization to transmit buffered data; and
means for timing an amount of time since transmission of the buffer status report and expiring after a selected amount of time,
wherein the means for generating is also for determining, after expiration of the means for timing, whether the information indicative of an authorization to transmit the buffered data has been received, and
wherein the means for transmitting is also for re-transmitting the buffer status report if a data condition has been met after expiration of the means for timing.

16. The apparatus of claim 15, wherein the data condition is that the means for receiving has not received the information indicative of an authorization to transmit the buffered data.

17. The apparatus of claim 15, wherein the means for generating is also for determining, after expiration of the means for timing, whether the means for buffering data includes buffered data, and wherein the data condition is that the means for receiving has not received the information indicative of an authorization to transmit the buffered data, and the means for generating has determined that the means for buffering data includes buffered data.

18. The apparatus of claim 15, wherein the means for timing is configured by a means for communication to which the apparatus is communicatively coupled.

19. A method that facilitates buffer status report robustness, the method comprising:
receiving a buffer status report re-transmitted from an access terminal;
transmitting to the access terminal, information indicative of an authorization to transmit data, in response to receiving the buffer status report re-transmitted from the access terminal and determining that a required amount of data is buffered for transmission,
wherein the buffer status report is re-transmitted from the access terminal after a selected amount of time since the access terminal transmitted an initial buffer status report and when data conditions are met.

20. The method of claim 19, wherein the data conditions include: the information indicative of an authorization to transmit data has not been received by the access terminal, and a determination by the access terminal has been made that data is buffered for transmission.

21. The method of claim 19, wherein the data conditions include: the information indicative of an authorization to transmit data has not been received by the access terminal.

22. The method of claim 19, wherein the information indicative of an authorization to transmit data is an uplink grant.

23. The method of claim 19, wherein the buffer status report re-transmitted from the access terminal is received on a Medium Access Control (MAC) Hybrid Automatic Repeat Request (HARQ) layer.

24. The method of claim 19, further comprising transmitting configuration information indicative of the selected amount of time.

25. The method of claim 19, further comprising transmitting configuration information for determining the data conditions.

26. A computer program product, comprising:
a computer-readable medium comprising:
code for receiving a buffer status report re-transmitted from an access terminal; and
code for, in response to receiving the buffer status report re-transmitted from the access terminal and determining that a required amount of data is buffered for transmission, transmitting to the access terminal, information indicative of an authorization to transmit data,
wherein the buffer status report re-transmitted from the access terminal is re-transmitted after a selected amount of time since the access terminal transmitted an initial buffer status report and when data conditions are met.

27. The computer program product of claim 26, wherein the data conditions are that the information indicative of authorization to transmit data has not been received.

28. The computer program product of claim 26, further comprising:
code for determining, after the selected amount of time since the access terminal transmitted the initial buffer status report, whether data is buffered for transmission, and
wherein the data conditions are that information indicative of authorization to transmit data has not been received, and a determination has been made that data is buffered for transmission.

29. An apparatus that facilitates buffer status report robustness, the apparatus comprising:
a transmitter module configured to transmit information indicative of an authorization to transmit data buffered at an access terminal;
a receiver module configured to receive a buffer status report re-transmitted from the access terminal after a selected amount of time since the access terminal transmitted an initial buffer status report and when data condition are met; and
a controller module configured to:
evaluate the buffer status report re-transmitted from the access terminal;
determine whether a required amount of data is buffered at the access terminal for transmission; and
in response to determining that a required amount of data is buffered at the access terminal for transmission, control the transmitter module to transmit to the access terminal, the information indicative of the authorization to transmit the data buffered at the access terminal.

30. The apparatus of claim 29, wherein the data condition includes: the information indicative of the authorization to transmit the data has not been received by the access terminal, and a determination by the access terminal has been made that data is buffered at the access terminal for transmission.

31. The apparatus of claim 29, wherein the data condition includes: the information indicative of the authorization to transmit the data has not been received by the access terminal.

32. The apparatus of claim 29, wherein the information indicative of authorization to transmit the data is an uplink grant.

33. The apparatus of claim 29, wherein the controller module is also configured to configure a timer module at an access terminal to which the apparatus is communicatively coupled.

34. An apparatus that facilitates buffer status report robustness, the apparatus comprising:
means for transmitting information indicative of an authorization to transmit data buffered at a user communication means;
means for receiving a buffer status report re-transmitted from the user communication means after a selected amount of time since the user communication means transmitted an initial buffer status report has elapsed and when data conditions are met; and
means for controlling, the means for controlling being configured to:
evaluate the buffer status report re-transmitted from the user communication means;
determine whether a required amount of data is buffered at the user communication means for transmission; and
in response to determining that a required amount of data is buffered at the user communication means for transmission, control the means for transmitting to transmit to the user communication means, the information indicative of an authorization to transmit data buffered at the user communication means.

35. The apparatus of claim 34, wherein the data conditions include: the information indicative of an authorization to transmit data buffered has not been received by the user communication means, and a determination by the user communication means has been made that data is buffered at the user communication means for transmission.

36. The apparatus of claim 34, wherein the data conditions include: information indicative of an authorization to transmit data buffered has not been received by the user communication means.

37. The apparatus of claim 34, wherein the means for controlling is further configured to generate and transmit information for configuring the selected amount of time at the user communication means.

38. A system for facilitating buffer status report robustness, the system comprising:
a wireless communication channel;
a base station configured to communicate over the wireless communication channel; and
an access terminal configured to transmit and re-transmit to the base station over the wireless communication channel, the access terminal comprising:
a buffer module configured to store buffered data;
a first controller module configured to generate a buffer status report indicative of an amount of the buffered data;
a first transmitter module configured to transmit the buffer status report to the base station;
a first receiver module configured to receive information indicative of an authorization to transmit the buffered data, wherein the information indicative of an authorization to transmit the buffered data is received from the base station; and
a timer module configured to expire after a selected amount of time since transmission of the buffer status report to the base station,
wherein the first controller module is also configured to determine, after expiration of the timer module, whether the information indicative of an authorization to transmit the buffered data has been received, and
wherein the first transmitter module is also configured to re-transmit the buffer status report if a data condition has been met after expiration of the timer module.

39. The system of claim 38, wherein the base station comprises:
a second transmitter module configured to transmit the information indicative of an authorization to transmit a buffered data at the access terminal; and
a second receiver module configured to receive the buffer status report that is re-transmitted from the access terminal when data conditions are met.

40. The system of claim 39, wherein the base station further comprises a second controller module configured to generate information for configuring the selected amount of time at the access terminal.

41. The system of claim 38, wherein the data condition is that the first receiver module has not received information indicative of an authorization to transmit the buffered data.

42. The system of claim 38, wherein the first controller module is further configured to determine, after expiration of the timer module, whether the buffer module is storing buffered data, and wherein the data condition is that the first receiver module has not received the information indicative of an authorization to transmit the buffered data, and the first controller module has determined that the buffer module is storing buffered data.

43. The system of claim 38, wherein the information indicative of an authorization to transmit the buffered data is an uplink grant.

44. The system of claim 38, wherein the buffer status report is transmitted or re-transmitted on a Medium Access Control (MAC) Hybrid Automatic Repeat Request (HARQ) layer.

45. The system of claim 38, wherein the buffer status report is included in a MAC control element.

46. The system of claim 38, wherein the timer module is configured by the base station.

47. A method that facilitates buffer status report robustness, the method comprising:
transmitting a buffer status report;
tracking an amount of time elapsed since transmitting the buffer status report;
determining, after a selected amount of time since transmitting the buffer status report, whether information indicative of authorization to transmit buffered data has been received;
re-transmitting the buffer status report if the selected amount of time has elapsed and a data condition has been met;
receiving the buffer status report that is re-transmitted; and
transmitting to an access terminal, the information indicative of authorization to transmit buffered data, in response to receiving the buffer status report that is re-transmitted from the access terminal, and determining that a required amount of data is buffered for transmission.

48. The method of claim 47, wherein the data condition is that the information indicative of authorization to transmit the buffered data has not been received.

49. The method of claim 47, further comprising transmitting configuration information for determining the data condition to the access terminal.

50. The method of claim 47, further comprising transmitting configuration information indicative of the selected amount of time to the access terminal.
